(19) United States
(12) Patent Application Publication
(10) Pub. No.: US 2017/0343055 A1
(43) Pub. Date: Nov. 30, 2017

(54) COVER ASSEMBLY FOR A MOTOR VEHICLE CLUTCH INCLUDING PRESSURE PLATE

(71) Applicant: Schaeffler Technologies AG & Co. KG, Herzogenaurach (DE)

(72) Inventor: Irving BLANCO ZITLALPOPOCA, Puebla (MX)

(21) Appl. No.: 15/165,288

(22) Filed: May 26, 2016

(51) Int. Cl. F16D 13/71; F16D 13/44; F16D 13/58; F16D 13/70

(52) U.S. Cl. CPC F16D 13/71; F16D 13/585; F16D 13/44; F16D 2013/586; F16D 2300/12; F16D 2300/26; F16D 2013/706

(57) ABSTRACT

A cover assembly for a motor vehicle clutch is provided. The cover assembly includes a cover, a pressure plate, a leaf spring connecting the pressure plate to the cover such that the pressure plate is axially movable with respect to the cover, an actuator plate configured for axially moving the pressure plate away from the cover and a retainer fixed to the pressure plate. The retainer is arranged for limiting liftoff of the actuator plate from the pressure plate. The cover assembly also includes a washer sandwiched axially between the retainer and the leaf spring. A method of constructing a cover assembly for a motor vehicle clutch is also provided.

The present disclosure relates generally to clutches and more specifically to retaining assemblies for pressure plates.

### BACKGROUND

WO 2016/026492, U.S. Pat. No. 8,689,959, WO 2015/176701, U.S. Pub. No. 2013/0313065 and EP 2824346 disclose examples of clutch cover assemblies.

### SUMMARY OF THE INVENTION

A cover assembly for a motor vehicle clutch is provided. The cover assembly includes a cover, a pressure plate, a leaf spring connecting the pressure plate to the cover such that the pressure plate is axially movable with respect to the cover, an actuator plate configured for axially moving the pressure plate away from the cover and a retainer fixed to the pressure plate. The retainer is arranged for limiting liftoff of the actuator plate from the pressure plate. The cover assembly also includes a washer sandwiched axially between the retainer and the leaf spring.

A method of constructing a cover assembly for a motor vehicle clutch is also provided. The method includes providing an actuator plate axially between a pressure plate and a radially extending section of a cover, the actuator plate being configured for axially moving the pressure plate away from the cover; connecting the pressure plate to the cover with a leaf spring such that the pressure plate is axially movable with respect to the cover; and fixing the leaf spring, a retainer and a washer to the pressure plate such that the washer is sandwiched axially between the retainer and the leaf spring, the retainer being arranged for limiting liftoff of the actuator plate from the pressure plate.

### BRIEF DESCRIPTION OF THE DRAWINGS

The present invention is described below by reference to the following drawings, in which:

FIG. 1 shows a cross-sectional perspective view a cover assembly for a motor vehicle clutch in accordance with an embodiment of the present invention;

FIG. 2 shows a view of an outer diameter of the cover assembly shown in FIG. 1, illustrating the shape of a leaf spring and the attachment of a first tangential end thereof to a pressure plate and a second tangential end thereof to a cover;

FIG. 3 shows a perspective view of the cover assembly shown in FIGS. 1 and 2; and

FIG. 4 shows a perspective view of the cover assembly shown in FIGS. 1 to 3 with a portion thereof cut-away.

### DETAILED DESCRIPTION

A cover assembly is provided that includes a washer between a clip and leaf spring in order to increase a leaf spring force while reducing a clip height using an existing clip and leaf spring. By using the washer, a clip force is reduced to a durable level and a leaf spring force is increased to an acceptable level.

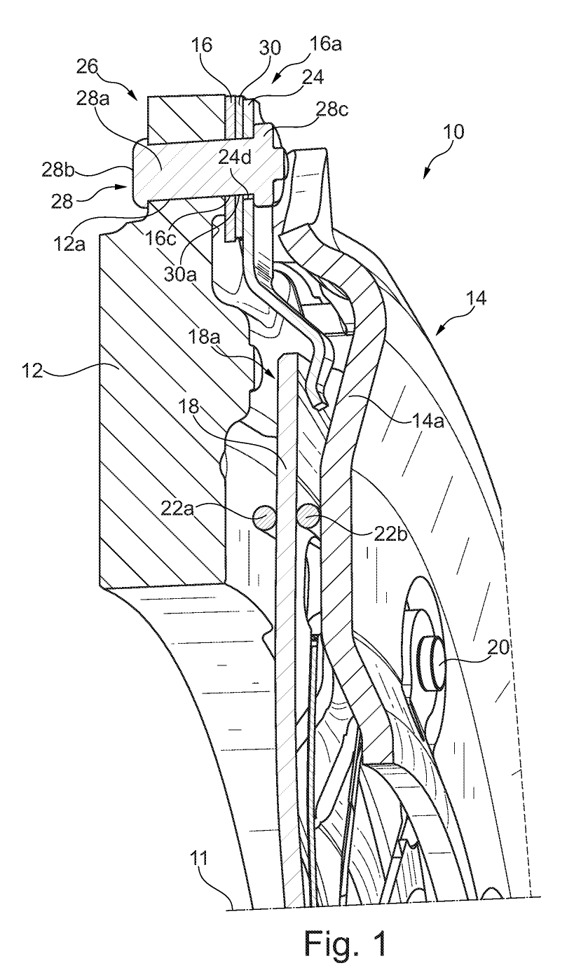

FIG. 1 shows a cross-sectional perspective view a cover assembly 10 for a motor vehicle clutch in accordance with an embodiment of the present invention. Cover assembly 10 is rotatable about a center axis 11 and includes a pressure plate 12 connected to a cover 14 by a leaf spring 16 such that pressure plate 12 is axially movable with respect to cover 14. The terms axially, radially and circumferentially as used herein are used with respect to center axis 11. Pressure plate 12 is movable axially away from cover 14 to force a clutch plate again a counter pressure plate. Cover assembly 10 further includes an actuator plate in the form of a diaphragm spring 18 axially between pressure plate 12 and a radially extending inner section 14a of cover 14 for axially moving pressure plate 12 away from radially extending inner section 14a of cover 10. Diaphragm spring 18 is fixed to cover 14 by fasteners, which in this embodiment are bolts 20, and two wire rings 22a, 22b. In a manner similar to that disclosed in U.S. Pub. No. 2013/0313065, which is hereby incorporated by reference herein, diaphragm spring 18 is configured for pivoting at wire rings 22a, 22b such that an outer radial end 18a of diaphragm spring 18 moves axially and forces pressure plate 12 axially away from cover 14. Wire rings 22a, 22b sit on an outer radial surface of bolts 20, with first wire ring 22a contacting a pressure plate facing surface of diaphragm spring 18 and a second wire ring 22b contacting a cover facing surface of diaphragm spring 18.

Cover assembly 10 also includes a plurality of retainers in the form of clips 24 arranged for limiting liftoff of diaphragm spring 18 from pressure plate 12. Clips 24 are fixed to an outer radial end 26 of pressure plate 12 by fasteners, which in this embodiment are rivets 28. Clips 24 each include a flat radially extending outer section 24a that is perpendicular to center axis 11 that includes a though hole 24d passed through by the respective rivet 28. At an inner radial end of outer section 24a, each clip 24 includes an intermediate section that extends axially away from pressure plate 12 and radially inward to join an inner section 24c, which is arranged from contacting the cover facing surface of diaphragm spring 18 to limit axial movement of diaphragm spring 18 away from pressure plate 12.

A first tangential end 16a of leaf spring 16 is also fixed to pressure plate 12 by rivet 28. At first tangential end 16a, leaf spring 16 is provided with a through hole 16c that is aligned with a through hole 12a of pressure plate 12, with rivet 28 passing through holes 16c, 12a. A washer 30 is also provided axially sandwiched between first tangential end 16a of leaf spring 16 and outer section 24a of clip 24 and similarly includes a through hole 30a in which rivet 28 passes through. A body 28a of rivet 28 extends axially through holes 12a, 16c, 30a, 24d, with a first head 28b of rivet 28 contacting a radially extending clutch facing surface of pressure plate 12 and a second head 28c of rivet 28 contacting a radially extending cover facing surface of outer section 24a of clip 24. Pressure plate 12, leaf spring 16, washer 30 and clip 24 are fixed together such that a radially extending cover facing surface of pressure plate 12 contacts a radially extending pressure plate facing surface of first tangential end 16a of leaf spring 16, a radially extending cover facing surface of first tangential end 16a of leaf spring 16 contacts a radially extending pressure plate facing surface of washer 30 and a radially extending cover facing surface of washer 30 contacts a radially extending pressure plate facing surface of outer section 24a of clip 24. Washer 30 spaces clips 24 and leaf spring 16 from each other to set the axial load in clips 24 caused by diaphragm spring 18 at acceptable levels to prevent damage or breaking of the slips 24 while allowing the load in leaf springs 16 to be at a sufficient amount.

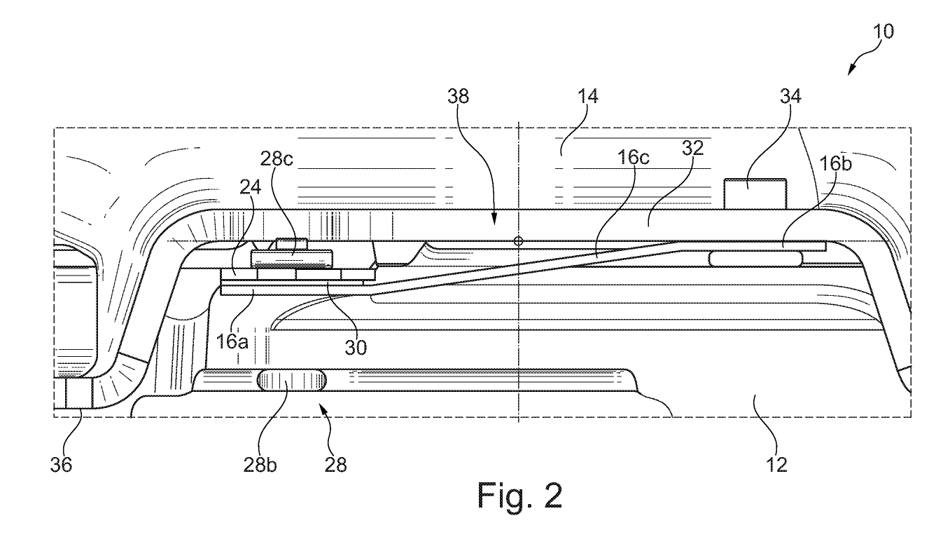

FIG. 2 shows a view of a portion of an outer diameter of cover assembly 10, illustrating the shape of leaf spring 16 and the attachment of first tangential end 16a thereof to pressure plate 12 and a second tangential end 16b thereof to cover 14. First tangential end 16a is flat and aligned perpendicular with center axis 11 (FIG. 1) and second tangential end 16b is also flat and aligned perpendicular with center axis 11, such that ends 16a, 16b are aligned parallel to each other. An angled body portion 16d of leaf spring 16 extends tangentially between ends 16a, 16b, while also extending axially between ends 16a, 16b such that ends 16a, 16b are spaced axially from one another. Second end 16b is fixed to a radially extending flange section 32 of cover 14 by a fastener 34 passing through a through hole in flange section 32 and a through hole in second end 16b. Flange section 32 is axially offset from a clutch side rim 36 of cover 14. A radially extending cover facing surface of second end 16b rests flush against a radially extending pressure plate facing surface of flange section 32. At an outer diameter thereof, cover 14 is provided with a tangentially extending cutout 38, which extends axially from flange section 32 to rim 36, allowing leaf spring 16, clip 24 and washer 30 to be viewed and accessed during assembly.

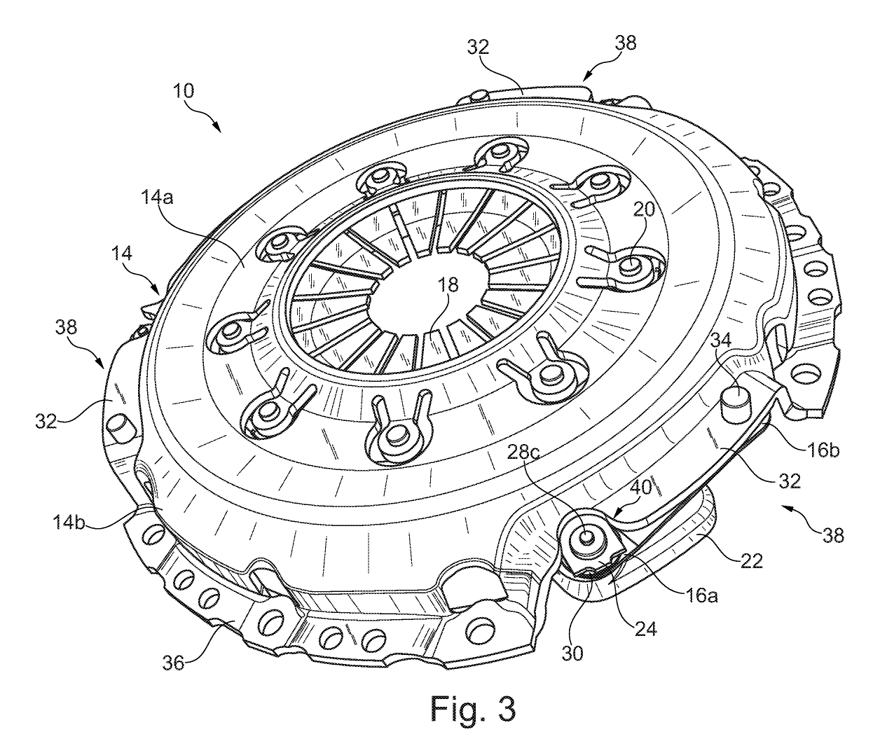

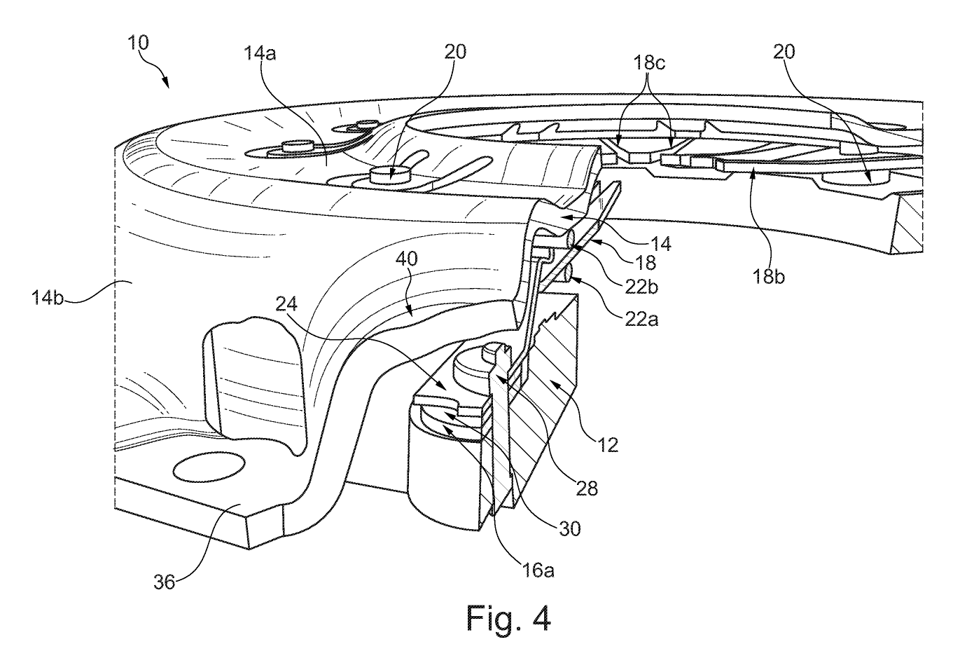

FIG. 3 shows a perspective view of cover assembly 10 and FIG. 4 shows a perspective view of cover assembly 10 with a portion thereof cut-away. As shown in FIG. 3, cover 14 is substantially bowl-shaped with circular cutout in the center thereof and includes radially extending inner section 14a, which bolts 20 pass through, extending radially outward from the inner diameter thereof and an axially and radially extending intermediate section 14b extending from inner section 14a to the radially extending outer rim 36. Flange sections 32 are formed in intermediate section 14b and cutouts 38 are formed in intermediate section 14b and rim 36. In this embodiment, cover assembly 10 includes three flange sections 32, each for contacting one second leaf spring end 16b and receiving one fastener 34, and three cutouts 38, each for receiving one set of a rivet 28, leaf spring 16, clip 24 and washer 30. Each flange section 32 is provided with a rounded cutout 40 that is contiguous with cutout 38 for receiving a tool for completing rivet 28 after diaphragm spring 18 is provided axially between cover 14 and pressure plate 12. FIG. 4 illustrates an inner radial end 18b of diaphragm spring 18 and bolts 20 passing through diaphragm spring 18, at radially extending slots 18c extending from the inner diameter of diaphragm spring 18, and passing through inner section 14a of cover 14. Additionally, the arrangement of wire rings 22a, 22b on bolt 22 is viewable in FIG. 4.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A cover assembly for a motor vehicle clutch comprising:
a cover;
a pressure plate;
a leaf spring connecting the pressure plate to the cover such that the pressure plate is axially movable with respect to the cover;
an actuator plate configured for axially moving the pressure plate away from the cover;
a retainer fixed to the pressure plate, the retainer being arranged for limiting liftoff of the actuator plate from the pressure plate; and
a washer sandwiched axially between the retainer and the leaf spring.

2. The cover assembly as recited in claim 1 further comprising a first fastener fixing the retainer, the washer and a first end of the leaf spring to the pressure plate.

3. The cover assembly as recited in claim 2 further comprising a second fastener fixing a second end of the leaf spring to the cover.

4. The cover assembly as recited in claim 1 wherein the retainer is a clip extending radially inward from the washer such that an inner radial end of the retainer is positioned axially between the cover and the actuator plate.

5. The cover assembly as recited in claim 1 wherein the actuator plate is a diaphragm spring fixed to the cover by fasteners and at least one wire ring, the diaphragm spring configured for pivoting at the least one wire ring to move the pressure plate axially away from the cover.

6. A method of constructing a cover assembly for a motor vehicle clutch comprising:
providing an actuator plate axially between a pressure plate and a radially extending section of a cover, the actuator plate being configured for axially moving the pressure plate away from the radially extending section of the cover;
connecting the pressure plate to the cover with a leaf spring such that the pressure plate is axially movable with respect to the cover; and
fixing the leaf spring, a retainer and a washer to the pressure plate such that the washer is sandwiched axially between the retainer and the leaf spring, the retainer being arranged for limiting liftoff of the actuator plate from the pressure plate.

7. The method as recited in claim 6 wherein the fixing the leaf spring, the retainer and the washer to the pressure plate includes providing a first fastener passing through the pressure plate, the retainer, the washer and a first end of the leaf spring to the pressure plate.

8. The method as recited in claim 7 wherein the connecting the pressure plate to the cover with the leaf spring includes providing a first fastener passing through a second end of the leaf spring and the cover.

9. The method as recited in claim 6 wherein the retainer is a clip extending radially inward from the washer such that an inner radial end of the retainer is positioned axially between the cover and the actuator plate.

10. The method as recited in claim 6 further comprising fixing the actuator plate to the cover by fasteners and at least one wire ring, the actuator plate configured for pivoting at the least one wire ring to move the pressure plate axially away from the cover.
